(19) United States
(12) Patent Application Publication
(10) Pub. No.: US 2015/0019575 A1
(43) Pub. Date: Jan. 15, 2015

(54) FILTERING CONTENT OF ONE OR MORE FEEDS IN AN ENTERPRISE SOCIAL NETWORKING SYSTEM INTO USER-CUSTOMIZABLE FEED CHANNELS

(71) Applicant: salesforce.com, inc., San Francisco, CA (US)

(72) Inventors: Alexandre Dayon, Paris (FR); Anna Bonner Mieritz, Moss Beach, CA (US); Scott Peter Perket, San Francisco, CA (US); Richard L. Spencer, II, Seattle, WA (US); Lorne Keith Trudeau, Bainbridge Island, WA (US); Craig Villamor, San Mateo, CA (US); William Gradin, San Francisco, CA (US)

(21) Appl. No.: 14/317,362

(22) Filed: Jun. 27, 2014

Related U.S. Application Data
(60) Provisional application No. 61/846,308, filed on Jul. 15, 2013.

(51) Int. Cl. G06F 17/30

(52) U.S. Cl. CPC G06F 17/30867
USPC 707/754

(57) ABSTRACT

Disclosed are examples of systems, apparatus, methods and computer-readable storage media for filtering feed content in an enterprise social networking system into user-customizable feed channels. Each feed channel is defined by a criterion or criteria customized by a user. Feed content published to one or more feeds is accessed. Portions of the feed content are identified that satisfy a criterion or criteria of a feed channel. A user device is operable to process data to display a list of the feed channels. Each feed channel in the displayed list is user-selectable to cause the display of the feed channel to include only the portion of feed content satisfying the criterion or criteria of the selected feed channel.

### PRIORITY DATA

This patent document claims priority to co-pending and commonly assigned U.S. Provisional Patent Application No. 61/846,308, titled “Filtering Enterprise Content in a Feed”, by Dayon et al., filed on Jul. 15, 2013 (Attorney Docket No. 1199PROV), which is hereby incorporated by reference in its entirety and for all purposes.

### COPYRIGHT NOTICE

A portion of the disclosure of this patent document contains material which is subject to copyright protection. The copyright owner has no objection to the facsimile reproduction by anyone of the patent document or the patent disclosure as it appears in the United States Patent and Trademark Office patent file or records but otherwise reserves all copyright rights whatsoever.

### TECHNICAL FIELD

This patent document generally relates to filtering content associated with social network feeds. More specifically, this patent document discloses techniques for filtering content of one or more feeds in an enterprise social networking system into user-customizable feed channels.

### BACKGROUND

“Cloud computing” services provide shared resources, applications, and information to computers and other devices upon request. In cloud computing environments, services can be provided by one or more servers accessible over the Internet rather than installing software locally on in-house computer systems. Technological details can be abstracted from the users who no longer have need for expertise in, or control over, the technology infrastructure “in the cloud” that supports them. By way of example, social networking services can be provided in a cloud computing context.

### BRIEF DESCRIPTION OF THE DRAWINGS

The included drawings are for illustrative purposes and serve only to provide examples of possible structures and operations for the disclosed inventive systems, apparatus, methods and computer-readable storage media for filtering content of one or more feeds in an enterprise social networking system into user-customizable feed channels. These drawings in no way limit any changes in form and detail that may be made by one skilled in the art without departing from the spirit and scope of the disclosed implementations.

FIG. 1A shows a flowchart of an example of a computer-implemented method 100A for filtering content of one or more feeds in an enterprise social networking system into user-customizable feed channels, performed in accordance with some implementations.

FIG. 1B shows a flowchart of an example of a computer-implemented method 100B capable of being practiced in combination with method 100A for filtering content of one or more feeds in an enterprise social networking system into user-customizable feed channels, performed in accordance with some implementations.

FIG. 2 shows a flowchart of an example of a computer-implemented method 200 for sharing feed channels with users, performed in accordance with some implementations.

FIG. 3 shows an example of presentations of feed channels and customizable criteria in the form of a graphical user interface (GUI) as displayed on a computing device, in accordance with some implementations.

FIG. 4 shows another example of presentations of feed channels and customizable criteria in the form of a GUI as displayed on a computing device, in accordance with some implementations.

FIG. 5 shows another example of presentations of feed channels and customizable criteria in the form of a GUI as displayed on a computing device, in accordance with some implementations.

FIG. 6A shows a block diagram of an example of an environment 10 in which an on-demand database service can be used in accordance with some implementations.

FIG. 6B shows a block diagram of an example of some implementations of elements of FIG. 6A and various possible interconnections between these elements.

FIG. 7A shows a system diagram of an example of architectural components of an on-demand database service environment 900, in accordance with some implementations.

FIG. 7B shows a system diagram further illustrating an example of architectural components of an on-demand database service environment, in accordance with some implementations.

### DETAILED DESCRIPTION

Examples of systems, apparatus, methods and computer-readable storage media according to the disclosed implementations are described in this section. These examples are being provided solely to add context and aid in the understanding of the disclosed implementations. It will thus be apparent to one skilled in the art that implementations may be practiced without some or all of these specific details. In other instances, certain operations have not been described in detail to avoid unnecessarily obscuring implementations. Other applications are possible, such that the following examples should not be taken as definitive or limiting either in scope or setting.

In the following detailed description, references are made to the accompanying drawings, which form a part of the description and in which are shown, by way of illustration, specific implementations. Although these implementations are described in sufficient detail to enable one skilled in the art to practice the disclosed implementations, it is understood that these examples are not limiting, such that other implementations may be used and changes may be made without departing from their spirit and scope. For example, the operations of methods shown and described herein are not necessarily performed in the order indicated. It should also be understood that the methods may include more or fewer operations than are indicated. In some implementations, operations described herein as separate operations may be combined. Conversely, what may be described herein as a single operation may be implemented in multiple operations.

Some implementations of the disclosed systems, apparatus, methods and computer-readable storage media are configured to filter the content of one or more feeds in an enterprise social networking system into user-customizable feed channels. For example, when a user would like to view certain feed content, she can specify a criterion or criteria defining the feed content she would like to view. In some implementations, a feed channel can be generated to include only feed content which: i) is already published to one or more social network feeds, and ii) satisfies specified criteria. In some implementations, one or more feed channels can be generated dynamically, that is, in near real-time in response to a user requesting or accessing the feed channel. As new content including posts, comments, record updates, and other various types of information updates described below is published to a feed or otherwise becomes accessible in a social networking system, new content satisfying the criterion or criteria will be viewable in the feed channel, keeping the user informed in any area she desires. If the user wants to seek out additional information, she can specify additional criteria, defining additional feed channels, or she can refine the information captured in an existing feed channel by editing the criteria defining that channel. Ultimately, by creating and customizing feed channels, the user can receive only the specific information she wants to receive in a well-organized, easy-to-consume fashion.

By way of illustration, a user who is an employee of a sales organization which uses an enterprise social networking system might only want to view information pertaining to specific Customer Relationship Management (CRM) records satisfying one or more criteria, such as opportunities in the Midwest region valued above one million dollars. Thus, a first criterion specifies only opportunities as one type of CRM record of interest, a second criterion specifies the Midwest as a geographic region of interest, and a third criterion specifies only records having a value meeting or exceeding a threshold of one million dollars. If the user customizes a feed channel based on the combination of these criteria, she will not have to waste time finding relevant feeds and combing through numerous irrelevant feed items looking for possibly relevant opportunities. Rather, any information updates published as feed items that identify or pertain to an opportunity that meet the specified criteria will be delivered directly to a feed channel, keeping the user informed of the latest developments in her region of choice.

In some implementations, user-customizable feed channels eliminate the burden of some conventional social networking systems that a user must follow, for example, by subscribing to, an object in order to receive feed content about that object. For example, in a conventional system, if Arlo would like to receive notifications of upcoming deals at Alice's Restaurant on his news feed, it might be necessary for Arlo to follow Alice's restaurant. In this scenario, if the news feed is Arlo's preferred or only form of electronic communication, Arlo might have difficulty discovering and trying new restaurants, instead being reliant on following restaurants about which he already knows. Ultimately, if Arlo wants to be informed of deals from new restaurants that he has never heard of but might like, Arlo may be out of luck. Alternatively, if Arlo creates a customized feed channel, selecting criteria that are important to him in selecting any restaurant, e.g., location, food type, price range, etc., he will be able to receive information regarding deals at restaurants fulfilling those criteria directly to his feed channel, sometimes without even knowing about the existence of such restaurants.

By placing relevant feed content in specific feed channels, a user can keep her feed content organized and easily digestible. For example, in some implementations, a user might specify criteria relating to her work to define a “work” channel. Along these lines, she might also define a “social” channel by specifying criteria that relate to her social life. This way, the user can easily separate her social and work life by keeping her social feed content and work-related feed content in separate feed channels. At the same time, in some implementations, the user can easily access relevant feed content by simply toggling between her “social” and “work” channels on her smartphone or other computing device.

In some implementations, user-customizable feed channels allow specific content to automatically flow in and out of a feed channel based on whether or not the content meets the defining criteria at a given time. By way of illustration, a user works in the Tier 3 Support group of the customer relations department at Acme Corporation, an organization which has implemented a social networking system for its employees. Tier 3 Support is only assigned to address specific cases, maintained as CRM records in a database, that have escalated to a certain priority level. For example, Tier 3 Support might only address medium priority and high priority cases that have an “open” status. Thus, Tier 3 Support would be burdened by receiving needless information relating to low priority or closed cases. In this example, a feed channel could be defined by specifying criteria that the channel only contains information related to open cases that are also medium or high priority. Considering the life and timeline of a CRM record such as a case, when case 1 begins as an open and low priority case, case 1 will not be included in Tier 3 Support's feed channel. At a later time, when case 1 escalates to high priority, case 1 will meet the criteria defining Tier 3 Support's customized feed channel and, therefore, published feed items and other social network information identifying or related to case 1 will flow into the feed channel for viewing by Tier 3 Support team members. Later, when the status of case 1 changes from “open” to “closed”, case 1 will no longer meet the criteria, and all information relating to case 1 will be removed from Tier 3 Support's feed channel. If case 1 reopens in the future, information relating to case 1 will then re-enter the feed channel. Thus, information can flow freely into the feed channel as criteria are met and flow out of the channel when criteria are no longer met, ensuring that the feed channel only contains relevant information at a given time and/or during a given stage of the life of a CRM record.

In some implementations, user-customizable feed channels allow a user to share feed content with others. For example, the sales department at Acme Corporation hires Maurice, a new employee who knows nothing about the Acme customer base. Jen, the head of Acme's sales department, can quickly and easily share a package of feed channels containing relevant content surrounding Acme's customers to quickly get Maurice up to speed. In some implementations, Maurice can be invited to or automatically caused to subscribe to the package of feed channels.

Some but not all of the techniques described or referenced herein are implemented in a social networking system. Social networking systems have become a popular way to facilitate communication among people, any of whom can be recognized as users of a social networking system. One example of a social networking system is Chatter®, provided by salesforce.com, inc. of San Francisco, Calif. salesforce.com, inc. is a provider of social networking services, CRM services and other database management services, any of which can be accessed and used in conjunction with the techniques disclosed herein in some implementations. These various services can be provided in a cloud computing environment, for example, in the context of a multi-tenant database system. Thus, the disclosed techniques can be implemented without having to install software locally, that is, on computing devices of users interacting with services available through the cloud. While the disclosed implementations are often described with reference to Chatter®, those skilled in the art should understand that the disclosed techniques are neither limited to Chatter® nor to any other services and systems provided by salesforce.com, inc. and can be implemented in the context of various other database systems and/or social networking systems such as Facebook®, LinkedIn®, Twitter®, Google+®, Yammer® and Jive® by way of example only.

Some social networking systems can be implemented in various settings, including organizations. For instance, a social networking system can be implemented to connect users within an enterprise such as a company or business partnership, or a group of users within such an organization. For instance, Chatter® can be used by employee users in a division of a business organization to share data, communicate, and collaborate with each other for various social purposes often involving the business of the organization. In the example of a multi-tenant database system, each organization or group within the organization can be a respective tenant of the system, as described in greater detail below.

In some social networking systems, users can access one or more social network feeds, which include information updates presented as items or entries in the feed. Such a feed item can include a single information update or a collection of individual information updates. A feed item can include various types of data including character-based data, audio data, image data and/or video data. A social network feed can be displayed in a graphical user interface (GUI) on a display device such as the display of a computing device as described below. The information updates can include various social network data from various sources and can be stored in an on-demand database service environment. In some implementations, the disclosed methods, apparatus, systems, and computer-readable storage media may be configured or designed for use in a multi-tenant database environment.

In some implementations, a social networking system may allow a user to follow data objects in the form of CRM records such as cases, accounts, or opportunities, in addition to following individual users and groups of users. The “following” of a record stored in a database, as described in greater detail below, allows a user to track the progress of that record when the user is subscribed to the record. Updates to the record, also referred to herein as changes to the record, are one type of information update that can occur and be noted on a social network feed such as a record feed or a news feed of a user subscribed to the record. Examples of record updates include field changes in the record, updates to the status of a record, as well as the creation of the record itself. Some records are publicly accessible, such that any user can follow the record, while other records are private, for which appropriate security clearance/permissions are a prerequisite to a user following the record.

Information updates can include various types of updates, which may or may not be linked with a particular record. For example, information updates can be social media messages submitted by a user or can otherwise be generated in response to user actions or in response to events. Examples of social media messages include: posts, comments, indications of a user's personal preferences such as “likes” and “dislikes”, updates to a user's status, uploaded files, and user-submitted hyperlinks to social network data or other network data such as various documents and/or web pages on the Internet. Posts can include alpha-numeric or other character-based user inputs such as words, phrases, statements, questions, emotional expressions, and/or symbols. Comments generally refer to responses to posts or to other information updates, such as words, phrases, statements, answers, questions, and reactionary emotional expressions and/or symbols. Multimedia data can be included in, linked with, or attached to a post or comment. For example, a post can include textual statements in combination with a JPEG image or animated image. A like or dislike can be submitted in response to a particular post or comment. Examples of uploaded files include presentations, documents, multimedia files, and the like.

Users can follow a record by subscribing to the record, as mentioned above. Users can also follow other entities such as other types of data objects, other users, and groups of users. Feed tracked updates regarding such entities are one type of information update that can be received and included in the user's news feed. Any number of users can follow a particular entity and thus view information updates pertaining to that entity on the users' respective news feeds. In some social networks, users may follow each other by establishing connections with each other, sometimes referred to as “friending” one another. By establishing such a connection, one user may be able to see information generated by, generated about, or otherwise associated with another user. For instance, a first user may be able to see information posted by a second user to the second user's personal social network page. One implementation of such a personal social network page is a user's profile page, for example, in the form of a web page representing the user's profile. In one example, when the first user is following the second user, the first user's news feed can receive a post from the second user submitted to the second user's profile feed. A user's profile feed is also referred to herein as the user's “wall,” which is one example of a social network feed displayed on the user's profile page.

In some implementations, a social network feed may be specific to a group of users of a social networking system. For instance, a group of users may publish a news feed. Members of the group may view and post to this group feed in accordance with a permissions configuration for the feed and the group. Information updates in a group context can also include changes to group status information.

In some implementations, when data such as posts or comments input from one or more users are submitted to a social network feed for a particular user, group, object, or other construct within a social networking system, an email notification or other type of network communication may be transmitted to all users following the user, group, or object in addition to the inclusion of the data as a feed item in one or more feeds, such as a user's profile feed, a news feed, or a record feed. In some social networking systems, the occurrence of such a notification is limited to the first instance of a published input, which may form part of a larger conversation. For instance, a notification may be transmitted for an initial post, but not for comments on the post. In some other implementations, a separate notification is transmitted for each such information update.

The term “multi-tenant database system” generally refers to those systems in which various elements of hardware and/or software of a database system may be shared by one or more customers. For example, a given application server may simultaneously process requests for a great number of customers, and a given database table may store rows of data such as feed items for a potentially much greater number of customers.

An example of a “user profile” or “user's profile” is a database object or set of objects configured to store and maintain data about a given user of a social networking system and/or database system. The data can include general information, such as name, title, phone number, a photo, a biographical summary, and a status, e.g., text describing what the user is currently doing. As mentioned below, the data can include social media messages created by other users. Where there are multiple tenants, a user is typically associated with a particular tenant. For example, a user could be a salesperson of a company, which is a tenant of the database system that provides a database service.

The term “record” generally refers to a data entity having fields with values and stored in database system. An example of a record is an instance of a data object created by a user of the database service, for example, in the form of a CRM record about a particular (actual or potential) business relationship or project. The record can have a data structure defined by the database service (a standard object) or defined by a user (custom object). For example, a record can be for a business partner or potential business partner (e.g., a client, vendor, distributor, etc.) of the user, and can include information describing an entire company, subsidiaries, or contacts at the company. As another example, a record can be a project that the user is working on, such as an opportunity (e.g., a possible sale) with an existing partner, or a project that the user is trying to get. In one implementation of a multi-tenant database system, each record for the tenants has a unique identifier stored in a common table. A record has data fields that are defined by the structure of the object (e.g., fields of certain data types and purposes). A record can also have custom fields defined by a user. A field can be another record or include links thereto, thereby providing a parent-child relationship between the records.

The terms “social network feed” and “feed” are used interchangeably herein and generally refer to a combination (e.g., a list) of feed items or entries with various types of information and data. Such feed items can be stored and maintained in one or more database tables, e.g., as rows in the table(s), that can be accessed to retrieve relevant information to be presented as part of a displayed feed. The term “feed item” (or feed element) generally refers to an item of information, which can be presented in the feed such as a post submitted by a user. Feed items of information about a user can be presented in a user's profile feed of the database, while feed items of information about a record can be presented in a record feed in the database, by way of example. A profile feed and a record feed are examples of different types of social network feeds. A second user following a first user and a record can receive the feed items associated with the first user and the record for display in the second user's news feed, which is another type of social network feed. In some implementations, the feed items from any number of followed users and records can be combined into a single social network feed of a particular user.

As examples, a feed item can be a social media message, such as a user-generated post of text data, and a feed tracked update to a record or profile, such as a change to a field of the record. Feed tracked updates are described in greater detail below. A feed can be a combination of social media messages and feed tracked updates. Social media messages include text created by a user, and may include other data as well. Examples of social media messages include posts, user status updates, and comments. Social media messages can be created for a user's profile or for a record. Posts can be created by various users, potentially any user, although some restrictions can be applied. As an example, posts can be made to a wall section of a user's profile page (which can include a number of recent posts) or a section of a record that includes multiple posts. The posts can be organized in chronological order when displayed in a GUI, for instance, on the user's profile page, as part of the user's profile feed. In contrast to a post, a user status update changes a status of a user and can be made by that user or an administrator. A record can also have a status, the update of which can be provided by an owner of the record or other users having suitable write access permissions to the record. The owner can be a single user, multiple users, or a group.

In some implementations, a comment can be made on any feed item. In some implementations, comments are organized as a list explicitly tied to a particular feed tracked update, post, or status update. In some implementations, comments may not be listed in the first layer (in a hierarchal sense) of feed items, but listed as a second layer branching from a particular first layer feed item.

A “feed tracked update,” also referred to herein as a “feed update,” is one type of information update and generally refers to data representing an event. A feed tracked update can include text generated by the database system in response to the event, to be provided as one or more feed items for possible inclusion in one or more feeds. In one implementation, the data can initially be stored, and then the database system can later use the data to create text for describing the event. Both the data and/or the text can be a feed tracked update, as used herein. In various implementations, an event can be an update of a record and/or can be triggered by a specific action by a user. Which actions trigger an event can be configurable. Which events have feed tracked updates created and which feed updates are sent to which users can also be configurable. Social media messages and other types of feed updates can be stored as a field or child object of the record. For example, the feed can be stored as a child object of the record.

A “group” is generally a collection of users. In some implementations, the group may be defined as users with a same or similar attribute, or by membership. In some implementations, a “group feed”, also referred to herein as a “group news feed”, includes one or more feed items about any user in the group. In some implementations, the group feed also includes information updates and other feed items that are about the group as a whole, the group's purpose, the group's description, and group records and other objects stored in association with the group. Threads of information updates including group record updates and social media messages, such as posts, comments, likes, etc., can define group conversations and change over time.

An “entity feed” or “record feed” generally refers to a feed of feed items about a particular record in the database. Such feed items can include feed tracked updates about changes to the record and posts made by users about the record. An entity feed can be composed of any type of feed item. Such a feed can be displayed on a page such as a web page associated with the record, e.g., a home page of the record. As used herein, a “profile feed” or “user's profile feed” generally refers to a feed of feed items about a particular user. In one example, the feed items for a profile feed include posts and comments that other users make about or send to the particular user, and status updates made by the particular user. Such a profile feed can be displayed on a page associated with the particular user. In another example, feed items in a profile feed could include posts made by the particular user and feed tracked updates initiated based on actions of the particular user.

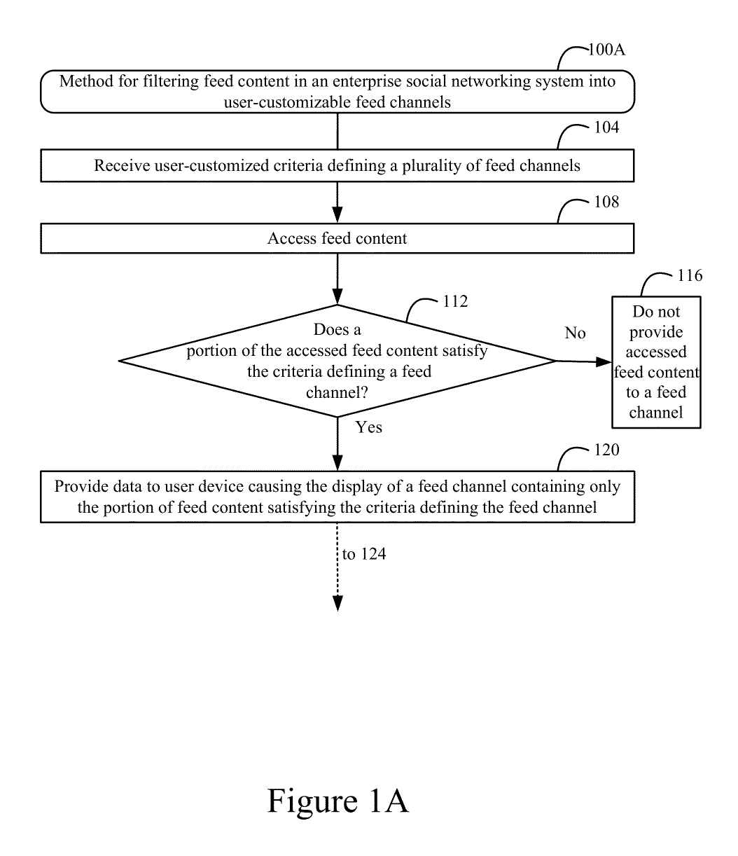

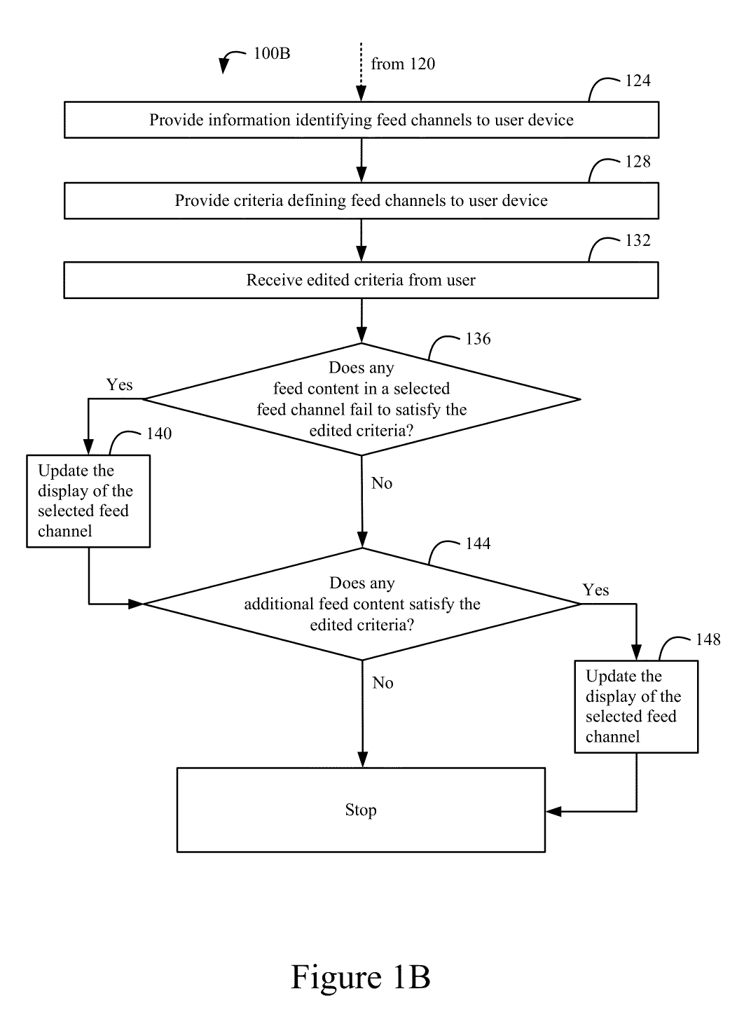

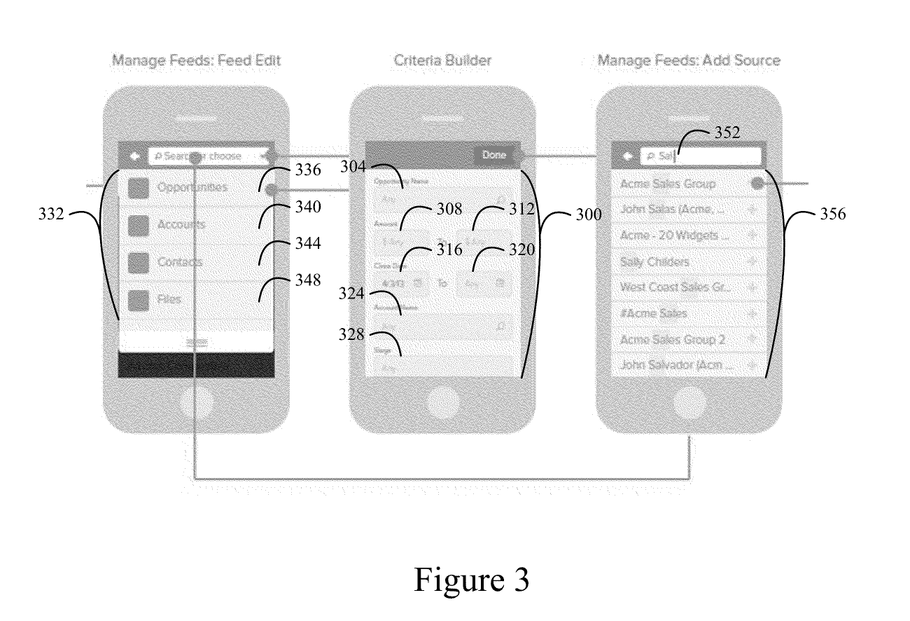

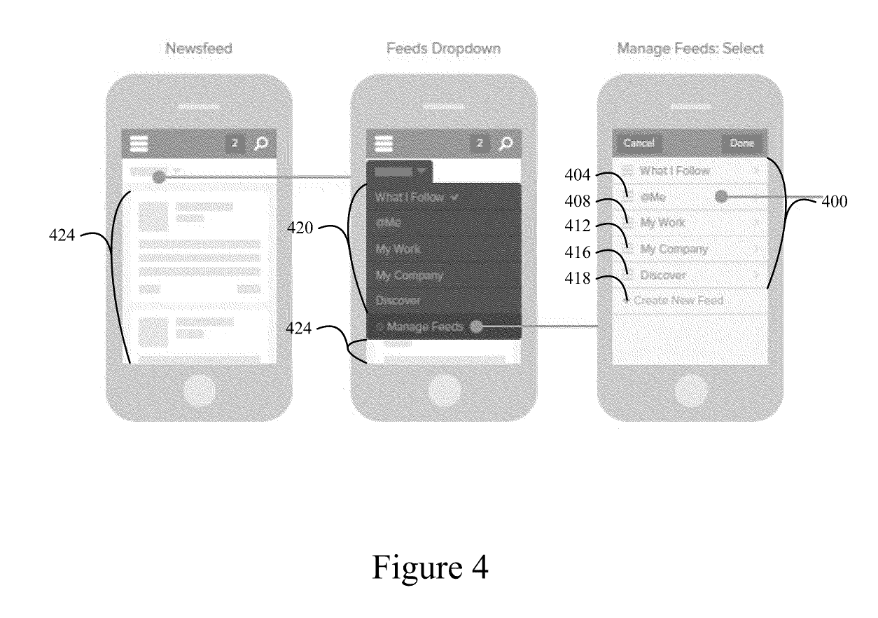

FIG. 1A shows a flowchart of an example of a computer-implemented method 100A for filtering content of one or more feeds in an enterprise social networking system into user-customizable feed channels, performed in accordance with some implementations. FIG. 1A is described with reference to FIGS. 3 and 4, which show examples of presentations of feed channels and customizable criteria in the form of a GUI as displayed on a computing device, in accordance with some implementations.

In the example of method 100A, at 104, user-customized criteria defining a plurality of feed channels 400 as shown in FIG. 4 is received. For example, FIG. 3 shows a set of criteria 300 customizable by a user using a computing device, where the criteria 300 defines a particular feed channel. A number of non-limiting examples of fields in which a user can specify and modify criteria relating to opportunities are shown in the example of FIG. 3. For example the user can specify an “Opportunity Name” 304, a “Minimum Amount” 308, a “Maximum Amount” 312, a range of “Close Dates” 316 to 320, an “Account Name” 324, and a “Stage” 328 as criteria which a database record would have to satisfy for feed items and other data pertaining to that record to be included in the feed channel. The user has an option to enter a value in a given field, e.g. the date “4/3/13” entered in field 316. Additionally, the user has an option to enter or select “Any” in each of the fields, e.g. field 304. In some implementations, if “Any” is entered in a field, there is no value associated with that field. For example, if a user enters “Any” in the “Opportunity Name” field 304 when defining a feed channel, content displayed in the feed channel will not be limited to a particular opportunity name.

In the specific example shown in FIG. 3, a user has the option to specify criteria relating to objects other than opportunities. To do so, the user might click or tap an item representing a category of objects in list 332. In this example, the user can specify criteria 300 relating to “Opportunities” 336 as described above and/or criteria relating to “Accounts” 340, “Contacts” 344, and “Files” 348. In some implementations, if the user clicks or taps an item such as “Accounts” 340, a set of fields relating to accounts, similar to the fields defining user-customizable criteria 300, would be displayed on the user device. The user could then enter values in the fields to define and customize criteria to identify published feed items relating to accounts. She could then repeat the process for other objects simply by clicking or tapping “Contacts” 344, “Files” 348 and so forth.

In some implementations, a set of criteria defining a feed channel can identify published feed content related to more than one data source such as various categories of database records and different users. For instance, a criterion might identify a particular data source, an attribute of any number of data sources, a type of a data source, a value of a record field, a related record in a hierarchical data model, a role of a user, a group, an attribute of a group, a type of a group, a file, a type of file, content of a file, a geographic region, a timeframe, a topic and a keyword.

Returning to the specific example shown in FIG. 3, a user might specify additional criteria by identifying additional data sources. In some implementations, the user can do so by typing the name of a source into search bar 352. As a user types the name of a source into search bar 352, matching sources will appear in list 356. In this example, after typing “Sal” in bar 352, the following data sources are identified in list 356: a particular group named “Acme Sales Group”, a particular user named “John Salas”, an opportunity named “Acme—20 Widgets” owned by the Acme Sales Group, another user named “Sally Childers”, another group named “West Coast Sales Group,” among other data sources. Of note, in some implementations, elements might begin to populate list 356 before a user has typed a complete source name into search bar 352 because list 356 is refreshed every time a user types or removes an additional character in search bar 352. Additionally, in some implementations, a user can add a data source by clicking or tapping the source in list 356.

As mentioned above, one or more criteria specified by a user, e.g. 300, are used to define one or more customizable feed channels. In some implementations, a user can follow a customized set of feed channels, in other words, enter a following relationship with one or more feed channels, regardless of whether the user is following records, users, groups or other entities to which feed items included in a channel are related. Thus, criteria can be specified to include feed content from entities which the user does not follow.

In some implementations, a user might choose to follow a feed channel that she generated herself by specifying criteria or she might simply follow a feed channel or a set of channels customized by another user. The sharing of feed channels among users is described in more detail below. FIG. 4 provides a non-limiting example of possible types of feed channels which a user might customize using criteria as explained above and follow. In addition to an “@me” feed channel 404 including feed items in which the user is @mentioned, the “My Work” feed channel 408 might include content relevant to customized specifics of a user's day-to-day work. The “My Company” feed channel 412 might include content relating generally to the company at which a user works. Lastly, the “Discover” feed channel 416 might be defined by automatically generated criteria. For instance, in some implementations, the criteria defining the “Discover” feed channel 416 might be generated using a machine learning algorithm processing user actions, user communications, target objects, and computing events satisfying parameters related to the user. Additionally, in some implementations, a user can generate a new feed channel simply by clicking or tapping the “Create New Feed” button 418.

Returning to FIG. 1A, at 108, content of one or more feeds is accessed. In some implementations, the accessed content has been published to the one or more feeds by or regarding one or more data sources in an enterprise social networking system, e.g. Chatter®, which is described in more detail above. A variety of data sources as described above can have possibly relevant feed content. In some enterprise social networking environments, data sources include identifiable records stored in a database, such as records including business information of one or more business organizations. In some implementations, these records might be CRM records including opportunities, contacts, leads, contracts, accounts, etc.

At 112, specific portions such as selected feed items of the accessed feed content that satisfy the criteria defining a feed channel are identified. For example, a combination of criteria may specify that only accounts for customers in the Midwest Region that are valued over one million dollars are to be included. In this scenario, where a given feed includes feed items pertaining to one or more accounts, only feed items satisfying the criteria are identified at 112 and provided to the feed channel. Feed items pertaining to accounts outside of the Midwest Region or pertaining to accounts valued below one million dollars would be excluded. At 116, any accessed feed content failing to satisfy the criteria will not be included in the feed channel and thus not displayed on a user device when the user taps on the feed channel. On the other hand, accessed feed content satisfying the criteria, e.g. content pertaining to accounts in the Midwest Region that are also valued over one million dollars, will be included in a feed channel and thus be capable of being displayed in a feed channel at 120.

At 120, each feed channel in a displayed list 420 of channels as shown in FIG. 4 is user-selectable to cause the display of the feed channel. For example, in some implementations a user might select a feed channel by tapping or clicking the feed channel on a computing device. In other implementations, a user might select a feed channel through a voice recognition feature of a computing device by speaking the name of the feed channel into the device. Along these lines, in some implementations, feed content associated with a feed channel might be delivered to a user in the form of audio presentation. For example, during her morning commute, a user might speak into a microphone in her car or smartphone asking to hear the content of her “Work” feed channel. The user's speech might cause an audio presentation from her phone or car stereo system reciting the most recent content in the “Work” feed channel.

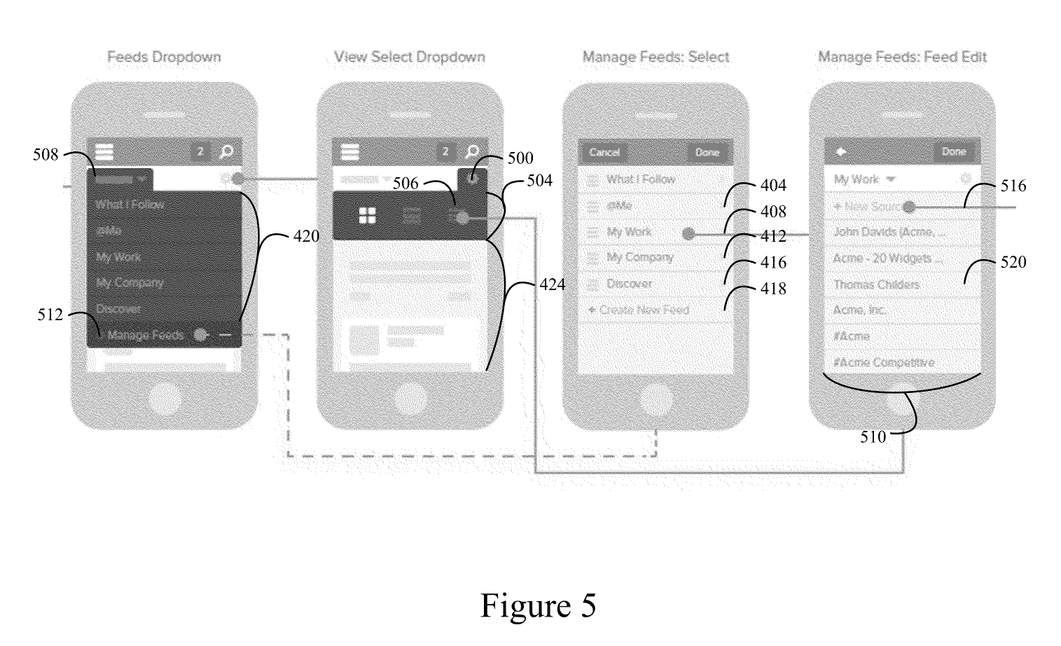

FIG. 1B shows a flowchart of an example of a computer implemented method 100B capable of being practiced in combination with method 100A for filtering content of one or more feeds in an enterprise social networking system into user-customizable feed channels, performed in accordance with some implementations. The processing of FIG. 1B generally relates to the editing of a selected feed channel after the generation of a plurality of feed channels as shown in FIG. 1A. FIG. 1B is described with reference to FIG. 5, which shows an example of how a user might edit the criteria defining a feed channel in a presentation of feed channels in the form of a GUI as displayed on a computing device, in accordance with some implementations.

In FIG. 1B, at 124, information identifying the feed channels is provided to the user device. In some implementations, each feed channel might be displayed in a list 420 shown in FIG. 5. Each feed channel in the list can be clicked or tapped to cause the display of the one or more criteria defining the selected feed channel. For instance, when viewing a specific feed channel, a user might click or tap “Settings” button 500 leading to a “View Select” drop down 504. At this point, the user can click or tap “Manage Feeds View” button 506 leading to the “Manage Feeds: Feed Edit” view 510. Additionally, the user could reach the same point by clicking or tapping the “Feeds Dropdown” field 508 leading to the display of list 420. The user could then click or tap the “Manage Feeds” button 512. At this point, when the user clicks or taps a feed channel she would like to edit, e.g. “My Work” 408, she will reach the “Manage Feeds: Feed Edit” view 510. Once the user reaches the “Manage Feeds: Feed Edit” view 510, the displayed criteria defining a given feed channel, e.g. “My Work” 408, are editable in a number of ways, some of which are described below. Additionally, the criteria can be stored at a server in the cloud and/or at the user device.

Returning to FIG. 1B, at 128, the criteria defining the feed channels is provided to the user device. In the specific example of FIG. 5, the criteria defining the feed channels can be accessed by going to the “Manage Feeds: Feed Edit” view 510 in one of the ways described above. In other implementations, the editable criteria might be accessed in a number of other ways, such as clicking on an “edit criteria” menu on the screen of a laptop computer. In yet other implementations, the criteria might be accessed through a voice recognition feature of a computing device, such as a smartphone, by speaking a phrase such as “edit criteria” into the device.

At 132 of FIG. 1B, edited criteria are received from a user. For example, a user could alter any values in fields specifying criteria 300 as described above with reference to FIG. 3. Also, a user could add or remove selected criteria. In FIG. 5, a user might want to add further feed content to her “My Work” feed channel by adding a new data source. The user could do so by clicking or tapping the “+New Source” button 516. Similarly, the user might want to get rid of a source such as “Thomas Childers” 520. In some implementations, the user could remove a source by clicking or tapping the source. In other implementations, a user might remove “Thomas Childers” 520 by speaking a phrase such as “remove Thomas Childers” into a smartphone or other computing device.

At 136 of FIG. 1B, if any feed content in a selected feed channel fails to satisfy the edited criteria, at 140, the display of the select feed channel will be updated such that the material not satisfying the criteria is removed from the feed channel. For example, if a user removes a specific data source, such as “Thomas Childers” 520 from the “My Work” channel, posts and comments by Thomas Childers will be removed from the user's “My Work” channel.

At 144, if any additional feed content satisfies the edited criteria, at 148, the display of the selected feed channel will be updated such that the additional feed content will be added to the selected feed channel. For example, when a user adds a new data source to her “My Work” channel by clicking or tapping the “+New Source” button 516, any additional feed content associated with the added data source will be added to the display of the user's “My Work” channel.

The editing and updating process described above can be repeated as many times as desired by a user. If the user wants to add or remove further criteria, she can again go to the “Manage Feeds: Feed Edit” view 510 of FIG. 5 in one of the variety of ways described above. Similarly, even if the one or more criteria defining a feed channel are not edited, the feed channel might still be updated. For instance, in some implementations, the content displayed in a feed channel might be updated every time a user views the feed channel. In other implementations, the content displayed in a feed channel might be updated every time new information is published to a feed or is made available online in the enterprise social networking system. In yet other implementations, the content displayed in a feed channel might be updated automatically at regular time intervals.

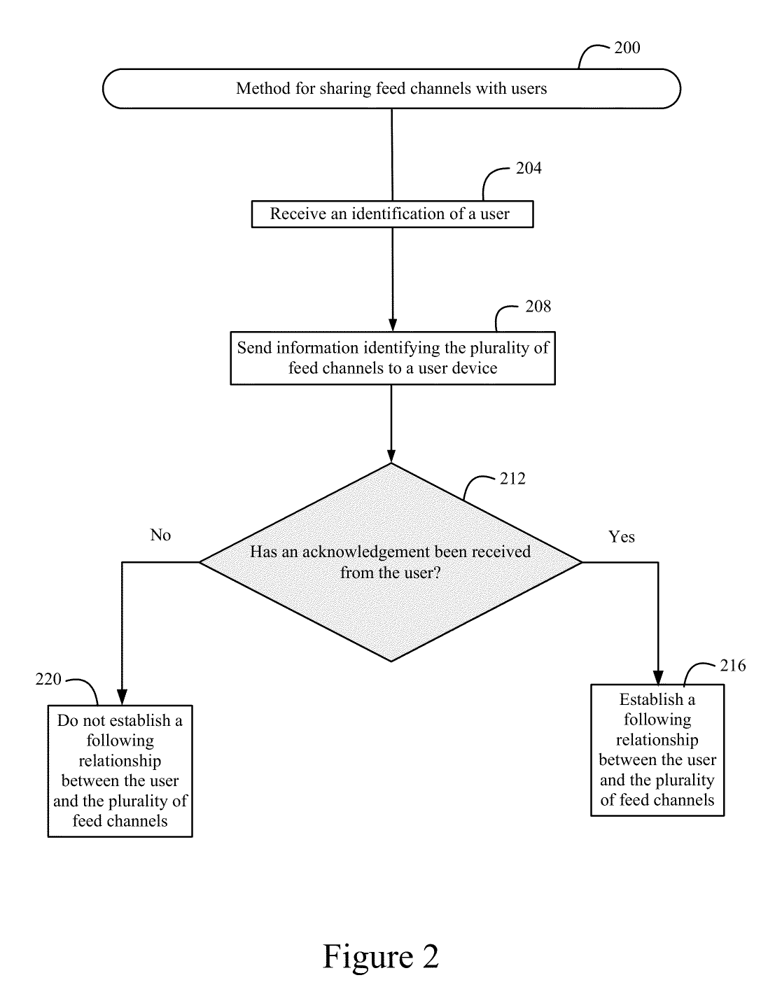

FIG. 2 shows a flowchart of an example of a computer-implemented method 200 for sharing feed channels by one user with other users, performed in accordance with some implementations. FIG. 2 can be performed in combination with or apart from the examples of FIGS. 1A and 1B. In this particular example, feed channels 400 of FIG. 4 have been generated for a first user as described above with reference to FIG. 1A. At 204, an identification of one or more second users with whom to share the feed channels 400 is received. For instance, when a manager determines that she would like to share work-related feed channels “My Work”408 and “My Company” 412 with her employee, the manager can identify her employee as a second user. At 208, information is sent to the second user's device identifying the plurality of feed channels. For example, in the situation described above, the employee might be sent a post, email, text message, etc. including an identification of the work-related feed channels on his smartphone. The second user has the option of subscribing to the feed channels or ignoring/rejecting the manager's communication. At 212, if the employee sends a reply post, email, text message, etc. acknowledging that she would like to follow the work related channels identified by his manager, a following relationship is established between the second user and the plurality of feed channels. Otherwise, at 212, when an acknowledgement is not received, a following relationship is not established at 220.

Notably, in some implementations described above, a user can receive filtered feed content from a data source without having to follow a specific data source. Content in a given feed channel is automatically generated based on criteria that define the feed channel. Therefore, rather than being in a following relationship with a data source a user can follow a variety of feed channels that she created or were shared with her.

Additionally, in some implementations described above, feed channels draw content from a variety of data sources such as accounts, opportunities, files, or even other social network feed channels. Criteria defining a given feed channel can be configured to identify feed content from a plurality of different types of data sources. For example, in one specific implementation, a single “Work” feed channel shared with employees of a given department might draw on a diverse set of data sources, from different types of CRM records such as accounts and opportunities, posts and electronic advertisements identifying happy hour specials at a local bar. In this scenario, as an incentive, a manager could set a criterion defining the “Work” feed channel such that happy hour specials are only displayed if employees meet certain benchmarks relating to the displayed opportunities or accounts.

While several non-limiting examples of types of feed content included in a feed channel are mentioned above, feed content can vary greatly in type across implementations. For instance, some additional non-limiting examples of types of feed content displayed in a social network feed channel might include feed items providing updates as to a workflow, a task, a create event, a meeting request, a calendar entry, a lead conversion, and a call logged. Systems, apparatus, and methods are described below for implementing database systems and enterprise level social and business information networking systems in conjunction with the disclosed techniques. Such implementations can provide more efficient use of a database system. For instance, a user of a database system may not easily know when important information in the database has changed, e.g., about a project or client. Such implementations can provide feed tracked updates about such changes and other events, thereby keeping users informed.

By way of example, a user can update a record in the form of a CRM object, e.g., an opportunity such as a possible sale of 1000 computers. Once the record update has been made, a feed tracked update about the record update can then automatically be provided, e.g., in a feed, to anyone subscribing to the opportunity or to the user. Thus, the user does not need to contact a manager regarding the change in the opportunity, since the feed tracked update about the update is sent via a feed to the manager's feed page or other page.

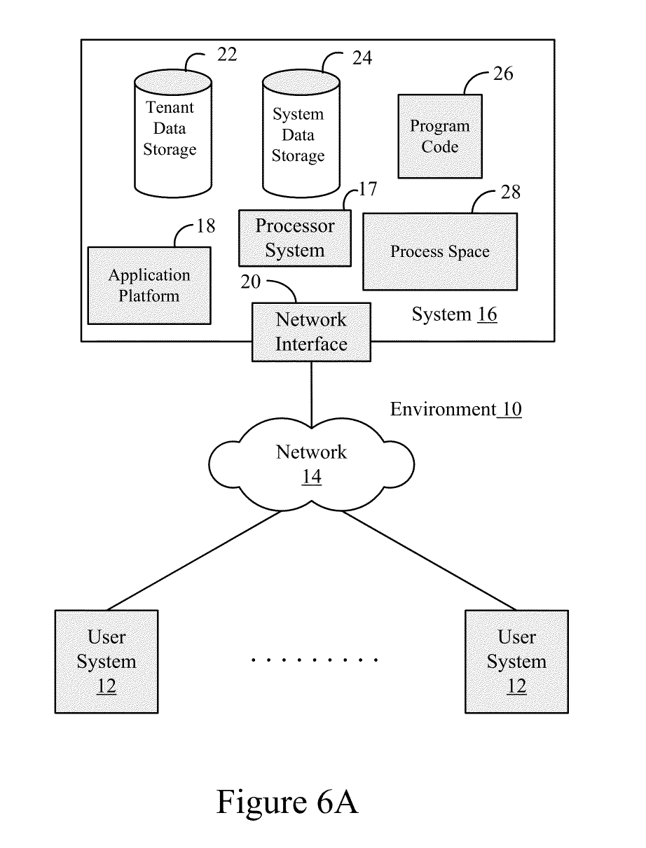

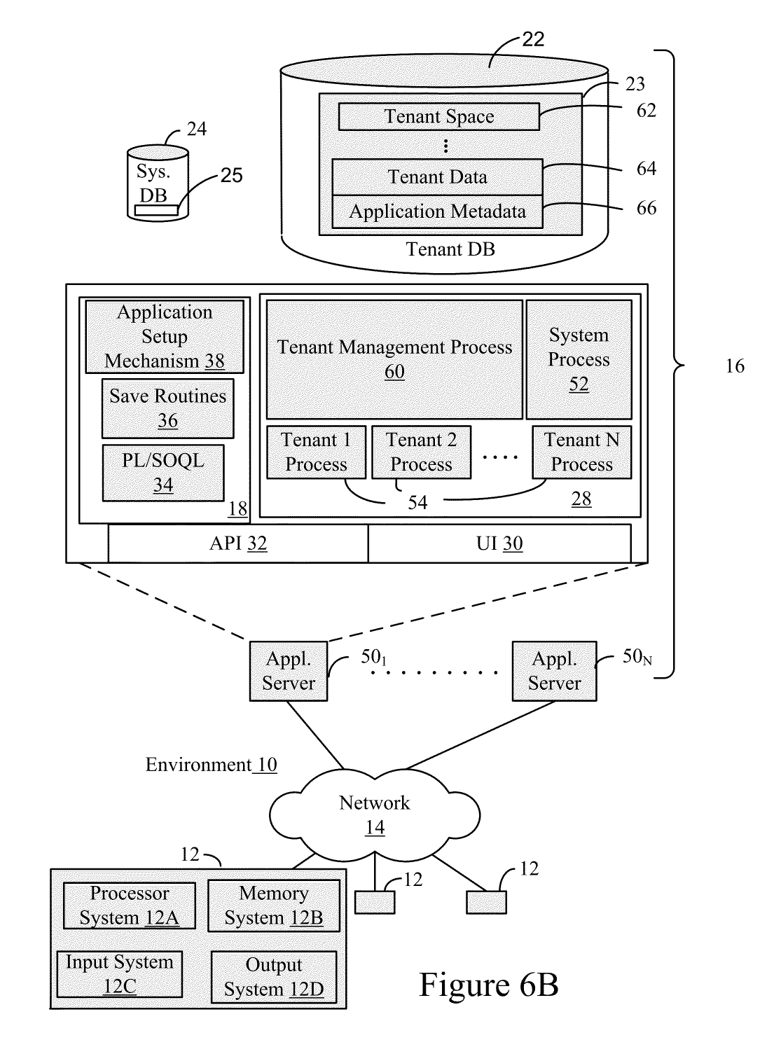

FIG. 6A shows a block diagram of an example of an environment 10 in which an on-demand database service exists and can be used in accordance with some implementations. Environment 10 may include user systems 12, network 14, database system 16, processor system 17, application platform 18, network interface 20, tenant data storage 22, system data storage 24, program code 26, and process space 28. In other implementations, environment 10 may not have all of these components and/or may have other components instead of, or in addition to, those listed above.

A user system 12 may be implemented as any computing device(s) or other data processing apparatus such as a machine or system used by a user to access a database system 16. For example, any of user systems 12 can be a handheld and/or portable computing device such as a mobile phone, a smartphone, a laptop computer, or a tablet. Other examples of a user system include computing devices such as a work station and/or a network of computing devices. As illustrated in FIG. 6A (and in more detail in FIG. 6B) user systems 12 might interact via a network 14 with an on-demand database service, which is implemented in the example of FIG. 6A as database system 16.

An on-demand database service, implemented using system 16 by way of example, is a service that is made available to users who do not need to necessarily be concerned with building and/or maintaining the database system. Instead, the database system may be available for their use when the users need the database system, i.e., on the demand of the users. Some on-demand database services may store information from one or more tenants into tables of a common database image to form a multi-tenant database system (MTS). A database image may include one or more database objects. A relational database management system (RDBMS) or the equivalent may execute storage and retrieval of information against the database object(s). Application platform 18 may be a framework that allows the applications of system 16 to run, such as the hardware and/or software, e.g., the operating system. In some implementations, application platform 18 enables creation, managing and executing one or more applications developed by the provider of the on-demand database service, users accessing the on-demand database service via user systems 12, or third party application developers accessing the on-demand database service via user systems 12.

The users of user systems 12 may differ in their respective capacities, and the capacity of a particular user system 12 might be entirely determined by permissions (permission levels) for the current user. For example, when a salesperson is using a particular user system 12 to interact with system 16, the user system has the capacities allotted to that salesperson. However, while an administrator is using that user system to interact with system 16, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level, also called authorization.

Network 14 is any network or combination of networks of devices that communicate with one another. For example, network 14 can be any one or any combination of a LAN (local area network), WAN (wide area network), telephone network, wireless network, point-to-point network, star network, token ring network, hub network, or other appropriate configuration. Network 14 can include a TCP/IP (Transfer Control Protocol and Internet Protocol) network, such as the global internetwork of networks often referred to as the Internet. The Internet will be used in many of the examples herein. However, it should be understood that the networks that the present implementations might use are not so limited.

User systems 12 might communicate with system 16 using TCP/IP and, at a higher network level, use other common Internet protocols to communicate, such as HTTP, FTP, AFS, WAP, etc. In an example where HTTP is used, user system 12 might include an HTTP client commonly referred to as a “browser” for sending and receiving HTTP signals to and from an HTTP server at system 16. Such an HTTP server might be implemented as the sole network interface 20 between system 16 and network 14, but other techniques might be used as well or instead. In some implementations, the network interface 20 between system 16 and network 14 includes load sharing functionality, such as round-robin HTTP request distributors to balance loads and distribute incoming HTTP requests evenly over a plurality of servers. At least for users accessing system 16, each of the plurality of servers has access to the MTS' data; however, other alternative configurations may be used instead.

In one implementation, system 16, shown in FIG. 6A, implements a web-based CRM system. For example, in one implementation, system 16 includes application servers configured to implement and execute CRM software applications as well as provide related data, code, forms, web pages and other information to and from user systems 12 and to store to, and retrieve from, a database system related data, objects, and Webpage content. With a multi-tenant system, data for multiple tenants may be stored in the same physical database object in tenant data storage 22, however, tenant data typically is arranged in the storage medium(s) of tenant data storage 22 so that data of one tenant is kept logically separate from that of other tenants so that one tenant does not have access to another tenant's data, unless such data is expressly shared. In certain implementations, system 16 implements applications other than, or in addition to, a CRM application. For example, system 16 may provide tenant access to multiple hosted (standard and custom) applications, including a CRM application. User (or third party developer) applications, which may or may not include CRM, may be supported by the application platform 18, which manages creation, storage of the applications into one or more database objects and executing of the applications in a virtual machine in the process space of the system 16.

One arrangement for elements of system 16 is shown in FIGS. 8A and 8B, including a network interface 20, application platform 18, tenant data storage 22 for tenant data 23, system data storage 24 for system data 25 accessible to system 16 and possibly multiple tenants, program code 26 for implementing various functions of system 16, and a process space 28 for executing MTS system processes and tenant-specific processes, such as running applications as part of an application hosting service. Additional processes that may execute on system 16 include database indexing processes.

Several elements in the system shown in FIG. 6A include conventional, well-known elements that are explained only briefly here. For example, each user system 12 could include a desktop personal computer, workstation, laptop, PDA, cell phone, or any wireless access protocol (WAP) enabled device or any other computing device capable of interfacing directly or indirectly to the Internet or other network connection. The term “computing device” is also referred to herein simply as a “computer”. User system 12 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 12 to access, process and view information, pages and applications available to it from system 16 over network 14. Each user system 12 also typically includes one or more user input devices, such as a keyboard, a mouse, trackball, touch pad, touch screen, pen or the like, for interacting with a GUI provided by the browser on a display (e.g., a monitor screen, LCD display, OLED display, etc.) of the computing device in conjunction with pages, forms, applications and other information provided by system 16 or other systems or servers. Thus, “display device” as used herein can refer to a display of a computer system such as a monitor or touch-screen display, and can refer to any computing device having display capabilities such as a desktop computer, laptop, tablet, smartphone, a television set-top box, or wearable device such Google Glass® or other human body-mounted display apparatus. For example, the display device can be used to access data and applications hosted by system 16, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

According to one implementation, each user system 12 and all of its components are operator configurable using applications, such as a browser, including computer code run using a central processing unit such as an Intel Pentium® processor or the like. Similarly, system 16 (and additional instances of an MTS, where more than one is present) and all of its components might be operator configurable using application(s) including computer code to run using processor system 17, which may be implemented to include a central processing unit, which may include an Intel Pentium® processor or the like, and/or multiple processor units. Non-transitory computer-readable media can have instructions stored thereon/in, that can be executed by or used to program a computing device to perform any of the methods of the implementations described herein. Computer program code 26 implementing instructions for operating and configuring system 16 to intercommunicate and to process web pages, applications and other data and media content as described herein is preferably downloadable and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any other type of computer-readable medium or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for the disclosed implementations can be realized in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to some implementations, each system 16 is configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to refer to one type of computing device such as a system including processing hardware and process space(s), an associated storage medium such as a memory device or database, and, in some instances, a database application (e.g., OODBMS or RDBMS) as is well known in the art. It should also be understood that “server system” and “server” are often used interchangeably herein. Similarly, the database objects described herein can be implemented as single databases, a distributed database, a collection of distributed databases, a database with redundant online or offline backups or other redundancies, etc., and might include a distributed database or storage network and associated processing intelligence.

FIG. 6B shows a block diagram of an example of some implementations of elements of FIG. 6A and various possible interconnections between these elements. That is, FIG. 6B also illustrates environment 10. However, in FIG. 6B elements of system 16 and various interconnections in some implementations are further illustrated. FIG. 6B shows that user system 12 may include processor system 12A, memory system 12B, input system 12C, and output system 12D. FIG. 6B shows network 14 and system 16. FIG. 6B also shows that system 16 may include tenant data storage 22, tenant data 23, system data storage 24, system data 25, User Interface (UI) 30, Application Program Interface (API) 32, PL/SOQL 34, save routines 36, application setup mechanism 38, application servers 50₁-50_{N}, system process space 52, tenant process spaces 54, tenant management process space 60, tenant storage space 62, user storage 64, and application metadata 66. In other implementations, environment 10 may not have the same elements as those listed above and/or may have other elements instead of, or in addition to, those listed above.

User system 12, network 14, system 16, tenant data storage 22, and system data storage 24 were discussed above in FIG. 6A. Regarding user system 12, processor system 12A may be any combination of one or more processors. Memory system 12B may be any combination of one or more memory devices, short term, and/or long term memory. Input system 12C may be any combination of input devices, such as one or more keyboards, mice, trackballs, scanners, cameras, and/or interfaces to networks. Output system 12D may be any combination of output devices, such as one or more monitors, printers, and/or interfaces to networks. As shown by FIG. 6B, system 16 may include a network interface 20 (of FIG. 6A) implemented as a set of application servers 50, an application platform 18, tenant data storage 22, and system data storage 24. Also shown is system process space 52, including individual tenant process spaces 54 and a tenant management process space 60. Each application server 50 may be configured to communicate with tenant data storage 22 and the tenant data 23 therein, and system data storage 24 and the system data 25 therein to serve requests of user systems 12. The tenant data 23 might be divided into individual tenant storage spaces 62, which can be either a physical arrangement and/or a logical arrangement of data. Within each tenant storage space 62, user storage 64 and application metadata 66 might be similarly allocated for each user. For example, a copy of a user's most recently used (MRU) items might be stored to user storage 64. Similarly, a copy of MRU items for an entire organization that is a tenant might be stored to tenant storage space 62. A UI 30 provides a user interface and an API 32 provides an application programmer interface to system 16 resident processes to users and/or developers at user systems 12. The tenant data and the system data may be stored in various databases, such as one or more Oracle® databases.

Application platform 18 includes an application setup mechanism 38 that supports application developers' creation and management of applications, which may be saved as metadata into tenant data storage 22 by save routines 36 for execution by subscribers as one or more tenant process spaces 54 managed by tenant management process 60 for example. Invocations to such applications may be coded using PL/SOQL 34 that provides a programming language style interface extension to API 32. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes, which manage retrieving application metadata 66 for the subscriber making the invocation and executing the metadata as an application in a virtual machine.

Each application server 50 may be communicably coupled to database systems, e.g., having access to system data 25 and tenant data 23, via a different network connection. For example, one application server 50₁ might be coupled via the network 14 (e.g., the Internet), another application server 50_{N-1} might be coupled via a direct network link, and another application server 50_{N} might be coupled by yet a different network connection. Transfer Control Protocol and Internet Protocol (TCP/IP) are typical protocols for communicating between application servers 50 and the database system. However, it will be apparent to one skilled in the art that other transport protocols may be used to optimize the system depending on the network interconnect used.

In certain implementations, each application server 50 is configured to handle requests for any user associated with any organization that is a tenant. Because it is desirable to be able to add and remove application servers from the server pool at any time for any reason, there is preferably no server affinity for a user and/or organization to a specific application server 50. In one implementation, therefore, an interface system implementing a load balancing function (e.g., an F5 Big-IP load balancer) is communicably coupled between the application servers 50 and the user systems 12 to distribute requests to the application servers 50. In one implementation, the load balancer uses a least connections algorithm to route user requests to the application servers 50. Other examples of load balancing algorithms, such as round robin and observed response time, also can be used. For example, in certain implementations, three consecutive requests from the same user could hit three different application servers 50, and three requests from different users could hit the same application server 50. In this manner, by way of example, system 16 is multi-tenant, wherein system 16 handles storage of, and access to, different objects, data and applications across disparate users and organizations.

As an example of storage, one tenant might be a company that employs a sales force where each salesperson uses system 16 to manage their sales process. Thus, a user might maintain contact data, leads data, customer follow-up data, performance data, goals and progress data, etc., all applicable to that user's personal sales process (e.g., in tenant data storage 22). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 16 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant-specific data, system 16 might also maintain system level data usable by multiple tenants or other data. Such system level data might include industry reports, news, postings, and the like that are sharable among tenants.

In certain implementations, user systems 12 (which may be client systems) communicate with application servers 50 to request and update system-level and tenant-level data from system 16 that may involve sending one or more queries to tenant data storage 22 and/or system data storage 24. System 16 (e.g., an application server 50 in system 16) automatically generates one or more SQL statements (e.g., one or more SQL queries) that are designed to access the desired information. System data storage 24 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in a multi-tenant database system. In certain implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

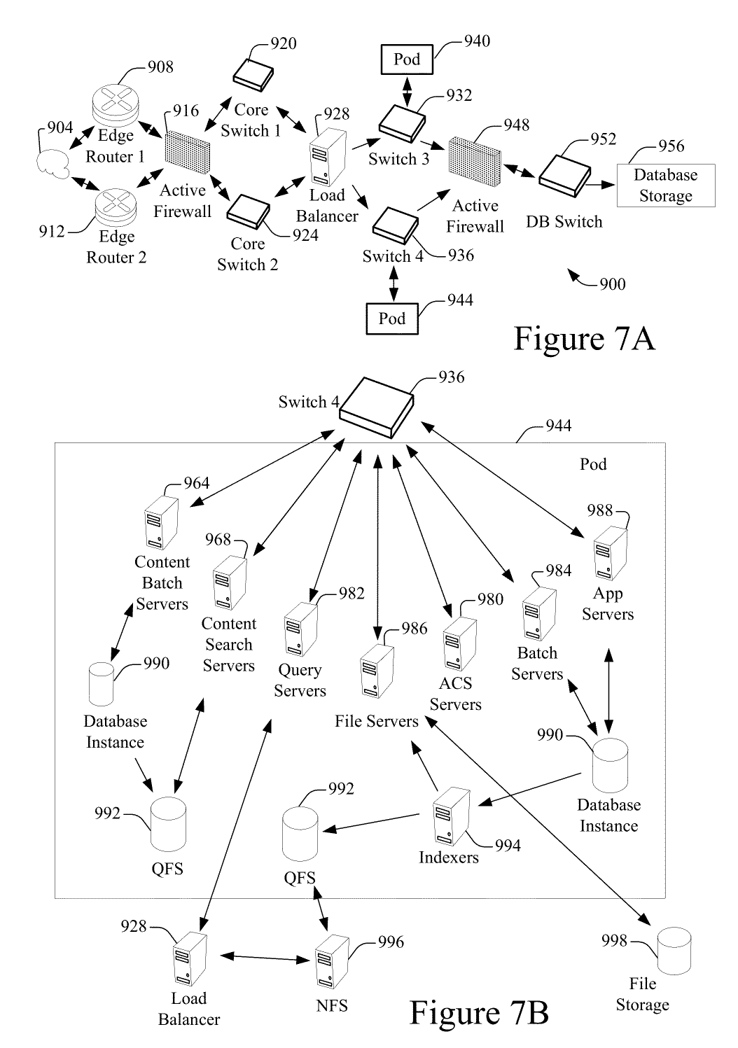

FIG. 7A shows a system diagram of an example of architectural components of an on-demand database service environment 900, in accordance with some implementations. A client machine located in the cloud 904, generally referring to one or more networks in combination, as described herein, may communicate with the on-demand database service environment via one or more edge routers 908 and 912. A client machine can be any of the examples of user systems 12 described above. The edge routers may communicate with one or more core switches 920 and 924 via firewall 916. The core switches may communicate with a load balancer 928, which may distribute server load over different pods, such as the pods 940 and 944. The pods 940 and 944, which may each include one or more servers and/or other computing resources, may perform data processing and other operations used to provide on-demand services. Communication with the pods may be conducted via pod switches 932 and 936. Components of the on-demand database service environment may communicate with a database storage 956 via a database firewall 948 and a database switch 952.

As shown in FIGS. 9A and 9B, accessing an on-demand database service environment may involve communications transmitted among a variety of different hardware and/or software components. Further, the on-demand database service environment 900 is a simplified representation of an actual on-demand database service environment. For example, while only one or two devices of each type are shown in FIGS. 9A and 9B, some implementations of an on-demand database service environment may include anywhere from one to many devices of each type. Also, the on-demand database service environment need not include each device shown in FIGS. 9A and 9B, or may include additional devices not shown in FIGS. 9A and 9B.

Moreover, one or more of the devices in the on-demand database service environment 900 may be implemented on the same physical device or on different hardware. Some devices may be implemented using hardware or a combination of hardware and software. Thus, terms such as “data processing apparatus,” “machine,” “server” and “device” as used herein are not limited to a single hardware device, but rather include any hardware and software configured to provide the described functionality.

The cloud 904 is intended to refer to a data network or combination of data networks, often including the Internet. Client machines located in the cloud 904 may communicate with the on-demand database service environment to access services provided by the on-demand database service environment. For example, client machines may access the on-demand database service environment to retrieve, store, edit, and/or process information.

In some implementations, the edge routers 908 and 912 route packets between the cloud 904 and other components of the on-demand database service environment 900. The edge routers 908 and 912 may employ the Border Gateway Protocol (BGP). The BGP is the core routing protocol of the Internet. The edge routers 908 and 912 may maintain a table of IP networks or ‘prefixes’, which designate network reachability among autonomous systems on the Internet.

In one or more implementations, the firewall 916 may protect the inner components of the on-demand database service environment 900 from Internet traffic. The firewall 916 may block, permit, or deny access to the inner components of the on-demand database service environment 900 based upon a set of rules and other criteria. The firewall 916 may act as one or more of a packet filter, an application gateway, a stateful filter, a proxy server, or any other type of firewall.

In some implementations, the core switches 920 and 924 are high-capacity switches that transfer packets within the on-demand database service environment 900. The core switches 920 and 924 may be configured as network bridges that quickly route data between different components within the on-demand database service environment. In some implementations, the use of two or more core switches 920 and 924 may provide redundancy and/or reduced latency.

In some implementations, the pods 940 and 944 may perform the core data processing and service functions provided by the on-demand database service environment. Each pod may include various types of hardware and/or software computing resources. An example of the pod architecture is discussed in greater detail with reference to FIG. 7B.

In some implementations, communication between the pods 940 and 944 may be conducted via the pod switches 932 and 936. The pod switches 932 and 936 may facilitate communication between the pods 940 and 944 and client machines located in the cloud 904, for example via core switches 920 and 924. Also, the pod switches 932 and 936 may facilitate communication between the pods 940 and 944 and the database storage 956.

In some implementations, the load balancer 928 may distribute workload between the pods 940 and 944. Balancing the on-demand service requests between the pods may assist in improving the use of resources, increasing throughput, reducing response times, and/or reducing overhead. The load balancer 928 may include multilayer switches to analyze and forward traffic.

In some implementations, access to the database storage 956 may be guarded by a database firewall 948. The database firewall 948 may act as a computer application firewall operating at the database application layer of a protocol stack. The database firewall 948 may protect the database storage 956 from application attacks such as structure query language (SQL) injection, database rootkits, and unauthorized information disclosure.

In some implementations, the database firewall 948 may include a host using one or more forms of reverse proxy services to proxy traffic before passing it to a gateway router. The database firewall 948 may inspect the contents of database traffic and block certain content or database requests. The database firewall 948 may work on the SQL application level atop the TCP/IP stack, managing applications' connection to the database or SQL management interfaces as well as intercepting and enforcing packets traveling to or from a database network or application interface.

In some implementations, communication with the database storage 956 may be conducted via the database switch 952. The multi-tenant database storage 956 may include more than one hardware and/or software components for handling database queries. Accordingly, the database switch 952 may direct database queries transmitted by other components of the on-demand database service environment (e.g., the pods 940 and 944) to the correct components within the database storage 956.

In some implementations, the database storage 956 is an on-demand database system shared by many different organizations. The on-demand database service may employ a multi-tenant approach, a virtualized approach, or any other type of database approach. On-demand database services are discussed in greater detail with reference to FIGS. 8A and 8B.

FIG. 7B shows a system diagram further illustrating an example of architectural components of an on-demand database service environment, in accordance with some implementations. The pod 944 may be used to render services to a user of the on-demand database service environment 900. In some implementations, each pod may include a variety of servers and/or other systems. The pod 944 includes one or more content batch servers 964, content search servers 968, query servers 982, file servers 986, access control system (ACS) servers 980, batch servers 984, and app servers 988. Also, the pod 944 includes database instances 990, quick file systems (QFS) 992, and indexers 994. In one or more implementations, some or all communication between the servers in the pod 944 may be transmitted via the switch 936.

In some implementations, the app servers 988 may include a hardware and/or software framework dedicated to the execution of procedures (e.g., programs, routines, scripts) for supporting the construction of applications provided by the on-demand database service environment 900 via the pod 944. In some implementations, the hardware and/or software framework of an app server 988 is configured to execute operations of the services described herein, including performance of one or more of the operations of methods described herein with reference to FIGS. 1-5. In alternative implementations, two or more app servers 988 may be included to perform such methods, or one or more other servers described herein can be configured to perform part or all of the disclosed methods.

The content batch servers 964 may handle requests internal to the pod. These requests may be long-running and/or not tied to a particular customer. For example, the content batch servers 964 may handle requests related to log mining, cleanup work, and maintenance tasks.

The content search servers 968 may provide query and indexer functions. For example, the functions provided by the content search servers 968 may allow users to search through content stored in the on-demand database service environment.

The file servers 986 may manage requests for information stored in the file storage 998. The file storage 998 may store information such as documents, images, and basic large objects (BLOBs). By managing requests for information using the file servers 986, the image footprint on the database may be reduced.

The query servers 982 may be used to retrieve information from one or more file systems. For example, the query system 982 may receive requests for information from the app servers 988 and then transmit information queries to the NFS 996 located outside the pod.

The pod 944 may share a database instance 990 configured as a multi-tenant environment in which different organizations share access to the same database. Additionally, services rendered by the pod 944 may call upon various hardware and/or software resources. In some implementations, the ACS servers 980 may control access to data, hardware resources, or software resources.

In some implementations, the batch servers 984 may process batch jobs, which are used to run tasks at specified times. Thus, the batch servers 984 may transmit instructions to other servers, such as the app servers 988, to trigger the batch jobs.

In some implementations, the QFS 992 may be an open source file system available from Sun Microsystems® of Santa Clara, Calif. The QFS may serve as a rapid-access file system for storing and accessing information available within the pod 944. The QFS 992 may support some volume management capabilities, allowing many disks to be grouped together into a file system. File system metadata can be kept on a separate set of disks, which may be useful for streaming applications where long disk seeks cannot be tolerated. Thus, the QFS system may communicate with one or more content search servers 968 and/or indexers 994 to identify, retrieve, move, and/or update data stored in the network file systems 996 and/or other storage systems.

In some implementations, one or more query servers 982 may communicate with the NFS 996 to retrieve and/or update information stored outside of the pod 944. The NFS 996 may allow servers located in the pod 944 to access information to access files over a network in a manner similar to how local storage is accessed.

In some implementations, queries from the query servers 922 may be transmitted to the NFS 996 via the load balancer 928, which may distribute resource requests over various resources available in the on-demand database service environment. The NFS 996 may also communicate with the QFS 992 to update the information stored on the NFS 996 and/or to provide information to the QFS 992 for use by servers located within the pod 944.

In some implementations, the pod may include one or more database instances 990. The database instance 990 may transmit information to the QFS 992. When information is transmitted to the QFS, it may be available for use by servers within the pod 944 without using an additional database call.

In some implementations, database information may be transmitted to the indexer 994. Indexer 994 may provide an index of information available in the database 990 and/or QFS 992. The index information may be provided to file servers 986 and/or the QFS 992.

While some of the disclosed implementations may be described with reference to a system having an application server providing a front end for an on-demand database service capable of supporting multiple tenants, the disclosed implementations are not limited to multi-tenant databases nor deployment on application servers. Some implementations may be practiced using various database architectures such as ORACLE®, DB2® by IBM and the like without departing from the scope of the implementations claimed.

It should be understood that some of the disclosed implementations can be embodied in the form of control logic using hardware and/or computer software in a modular or integrated manner. Other ways and/or methods are possible using hardware and a combination of hardware and software.

Any of the disclosed implementations may be embodied in various types of hardware, software, firmware, and combinations thereof. For example, some techniques disclosed herein may be implemented, at least in part, by computer-readable media that include program instructions, state information, etc., for performing various services and operations described herein. Examples of program instructions include both machine code, such as produced by a compiler, and files containing higher-level code that may be executed by a computing device such as a server or other data processing apparatus using an interpreter. Examples of computer-readable media include, but are not limited to: magnetic media such as hard disks, floppy disks, and magnetic tape; optical media such as flash memory, compact disk (CD) or digital versatile disk (DVD); magneto-optical media; and hardware devices specially configured to store program instructions, such as read-only memory (“ROM”) devices and random access memory (“RAM”) devices. A computer-readable medium may be any combination of such storage devices.

Any of the operations and techniques described in this application may be implemented as software code to be executed by a processor using any suitable computer language such as, for example, Java, C++ or Perl using, for example, object-oriented techniques. The software code may be stored as a series of instructions or commands on a computer-readable medium. Computer-readable media encoded with the software/program code may be packaged with a compatible device or provided separately from other devices (e.g., via Internet download). Any such computer-readable medium may reside on or within a single computing device or an entire computer system, and may be among other computer-readable media within a system or network. A computer system or computing device may include a monitor, printer, or other suitable display for providing any of the results mentioned herein to a user.

While various implementations have been described herein, it should be understood that they have been presented by way of example only, and not limitation. Thus, the breadth and scope of the present application should not be limited by any of the implementations described herein, but should be defined only in accordance with the following and later-submitted claims and their equivalents.

What is claimed is:

1. Apparatus comprising:
one or more processors operable to cause one or more computing devices to:
receive criteria customized by a user, the criteria defining a plurality of feed channels, each feed channel defined by a respective one or more of the criteria;
access content of one or more feeds, the content published to the one or more feeds by or regarding one or more data sources in an enterprise social networking system, the data sources comprising one or more identifiable records stored in a database, the records comprising business information of one or more business organizations;
identify portions of the feed content, each identified portion satisfying the respective one or more criteria defining a feed channel; and
provide data at a user device, the user device being operable to process the data to display a list of the feed channels, each feed channel in the displayed list being user-selectable to cause the display of the feed channel to include only the portion of feed content satisfying the one or more criteria defining a selected feed channel.

2. The apparatus of claim 1, the one or more processors further operable to cause one or more computing devices to:
establish, maintain or identify a following relationship between the user and the plurality of feed channels.

3. The apparatus of claim 1, the one or more processors further operable to cause one or more computing devices to:
receive an identification of a further user with whom to share the plurality of feed channels;
send information identifying the plurality of feed channels to a further user device associated with the further user;
receive a request from the further user device; and
establish a following relationship between the further user and the plurality of feed channels.

4. The apparatus of claim 1, wherein a following relationship does not exist between the user and the one or more data sources.

5. The apparatus of claim 1 further comprising a storage medium, wherein each feed channel in the displayed list is further user-selectable to cause the display of the one or more criteria defining the selected feed channel, the displayed one or more criteria being editable and storable on the storage medium using the user device to alter the user-customization of the feed channel.

6. The apparatus of claim 5, the one or more processors further operable to cause one or more computing devices to:
provide additional data at the user device, the user device being operable to process the additional data to:
update a display of the selected feed channel to remove feed content not satisfying an edited criterion, and
update the display of the selected feed channel to include additional feed content satisfying the edited criterion.

7. The apparatus of claim 5, the one or more processors further operable to cause one or more computing devices to:
provide information identifying the feed channels at the user device; and
provide information identifying the one or more criteria defining the selected feed channel at the user device.

8. The apparatus of claim 1, wherein criteria defining a feed channel are configured to identify feed content from a plurality of data sources of different types.

9. The apparatus of claim 1, wherein a criterion identifies one or more of: a data source, an attribute of a data source, a type of a data source, a record, an attribute of a record, a value of a record field, a type of a record, a related record in a hierarchical data model, a user, an attribute of a user, a role of a user, a group, an attribute of a group, a type of a group, a file, a type of a file, content of a file, a geographic region, a timeframe, a topic, and a keyword.

10. The apparatus of claim 1, wherein a portion of the accessed feed content comprises one or more of: a post, a comment, a like, a status update, a workflow, an uploaded document, a shared document, a hyperlink, a task, a task update, a note, a create event, a meeting request, a calendar entry, a lead conversion, a call logged, and a record update.

11. The apparatus of claim 1, wherein the user device is one of: a desktop computer, a laptop computer, a tablet, a smartphone, a television set-top box, and a wearable device.

12. The apparatus of claim 1, the one or more processors further operable to cause one or more computing devices to:
generate criteria defining a feed channel using a machine learning algorithm processing one or more of: user actions, user communications, target objects, and computing events.

13. The apparatus of claim 1, wherein the records are customer relationship management (CRM) records comprising one or more of: opportunities, contacts, leads, contracts and accounts.

14. The apparatus of claim 1 further comprising a database storing the criteria, wherein receiving the criteria comprises:
retrieving the criteria from the database.

15. A computer-implemented method for filtering content of one or more feeds in an enterprise social networking system into user-customizable feed channels, the method comprising:
receiving criteria customized by a user, the criteria defining a plurality of feed channels, each feed channel defined by a respective one or more of the criteria;
accessing, by a computing device, content of one or more feeds, the content published to the one or more feeds by or regarding one or more data sources in an enterprise social networking system, the data sources comprising one or more identifiable records stored in a database, the records comprising business information of one or more business organizations;
identifying portions of the feed content, each identified portion satisfying the respective one or more criteria defining a feed channel; and
providing data at a user device, the user device being operable to process the data to display a list of the feed channels, each feed channel in the displayed list being user-selectable to cause the display of the feed channel to include only the portion of feed content satisfying the one or more criteria defining a selected feed channel.

16. The method of claim 15, further comprising:
establishing, maintaining or identifying a following relationship between the user and the plurality of feed channels.

17. The method of claim 15, further comprising:
receiving an identification of a further user with whom to share the plurality of feed channels;
sending information identifying the plurality of feed channels to a further user device associated with the further user;
receiving a request from the further user device; and
establishing a following relationship between the further user and the plurality of feed channels.

18. The method of claim 15, wherein a following relationship does not exist between the user and the one or more data sources.

19. The method of claim 18, further comprising:
providing additional data at the user device, the user device being operable to process the additional data to:
update a display of the selected feed channel to remove feed content not satisfying an edited criterion, and
update the display of the selected feed channel to include additional feed content satisfying the edited criterion.

20. A non-transitory computer-readable storage medium storing instructions executable by a processor and configured to cause a method to be performed, the method comprising:
receiving, at a computing device, criteria customized by a user, the criteria defining a plurality of feed channels, each feed channel defined by a respective one or more of the criteria;
accessing content of one or more feeds, the content published to the one or more feeds by or regarding one or more data sources in an enterprise social networking system, the data sources comprising one or more identifiable records stored in a database, the records comprising business information of one or more business organizations;
identifying portions of the feed content, each identified portion satisfying the respective one or more criteria defining a feed channel; and
providing data at a user device, the user device being operable to process the data to display a list of the feed channels, each feed channel in the displayed list being user-selectable to cause the display of the feed channel to include only the portion of feed content satisfying the one or more criteria defining a selected feed channel.

21. The non-transitory computer-readable storage medium of claim 20, the method further comprising:
establishing, maintaining or identifying a following relationship between the user and the plurality of feed channels.

22. The non-transitory computer-readable storage medium of claim 20, the method further comprising:
receiving an identification of a further user with whom to share the plurality of feed channels;
sending information identifying the plurality of feed channels to a further user device associated with the further user;
receiving a request from the further user device; and
establishing a following relationship between the further user and the plurality of feed channels.
